(19) United States
(12) Patent Application Publication
(10) Pub. No.: US 2016/0036849 A1
(43) Pub. Date: Feb. 4, 2016

(54) Method, Apparatus and System for Detecting and Disabling Computer Disruptive Technologies

(71) Applicant: Hovannes Zakian, Burbank, CA (US)

(72) Inventor: Hovannes Zakian, Burbank, CA (US)

(21) Appl. No.: 14/815,906

(22) Filed: Jul. 31, 2015

Related U.S. Application Data
(60) Provisional application No. 62/033,084, filed on Aug. 4, 2014.

(51) Int. Cl. H04L 29/06

(52) U.S. Cl. CPC H04L 63/1441; H04L 63/1466

(57) ABSTRACT

Disruptive technology of network communication and security, such as Internet traffic blocking, diverting, or modifying is detected in a Host Machine. One or more servers utilize one or more web pages or resources to load and execute on a Host Machine software that detect operation blocking, diverting, or modifying behavior, which is indicative of the presence of malware on the Host Machine.

### CROSS-REFERENCE TO RELATED APPLICATION

The present application claims priority to provisional U.S. application No. 62/033,084, filed on Aug. 4, 2014, the content of which is included in its entirety herein by reference.

### FIELD OF THE INVENTION

The invention relates to digital data security and detection of disruptive technologies involved in fraud and compromising data safety and network communications. More specifically, the invention relates to a method and system of detecting the presence of disruptive computer software that may ex-filtrate online information, carry out digital advertising fraud, or cause a Host Machine to carry out any other unintended and/or unauthorized actions.

### BACKGROUND OF THE INVENTION

As more users and businesses rely on communications through networks of connected computers, such as the Internet, and conduct their activities electronically, Host Machine operators, content providers, and advertisers utilizing digital advertising have become the target of an underground economy that relies on installing malicious software, which is also known as malware, on end user computers e.g., user computers (also known as User Terminals), servers, control terminals, network traffic devices, hubs or any other device involved that may be able to access data, whether stored on disk and/or memory, or simply transiting through a network device. The latter is also commonly known as “infecting a host computer”. Often, the malware allows the instigator to gain control of the compromised systems leading to the ex-filtration of sensitive information and/or personal information, installation of utilities that facilitate remote control of the host, or installation of utility software that facilitates digital advertising fraud. For example, an instigator who can successfully compromise any of the devices involved in on-line transactions may gain access to banking and medical records, authorization credentials and personal communication records transactions or any other user sensitive and/or personal information, when transactions are carried out on the Internet.

Furthermore, as Internet usage has grown, advertisers have invested greater resources and budgets into advertising their products and/or services online. However, digital advertising is vulnerable to advertising fraud which may be carried out by simulating user behavior or modifying advertising performance attribution records that mislead the advertiser, ad network, or any other interested party with regards to the value delivered by a particular ad impression, view, click, or lead.

Therefore, there is a need for a method, apparatus and system to detect malware in infected computers, to provide efficient steps to detect malware, report the detection results to the appropriate parties and eventually take action to prevent the malware of causing harm.

### SUMMARY OF THE INVENTION

In one aspect, the invention is directed to a method for detecting disruptive technologies (i.e. malware) that compromise network traffic (e.g., blocking, diverting, or modifying network communication activity), such as between a User Terminal and a server. The method according to the invention comprises:
1.—providing one or more servers which serve a computer program (e.g., a routine) or a resource (e.g., an applet) capable of executing program code on the Host Machine (e.g., with a web browser). The program code is capable of determining whether the Host Machine is capable of testing access to a predetermined number/list of network addresses, network communication ports, network resources or any other computer/communication resource;
2.—determining whether a disruptive technology is present on the Host Machine by testing for the presence of blocking, diverting, or modifying behavior in the Host Machine; and
3.—if blocking, diverting, or modifying behavior is found, and malware is detected in the Host Machine, providing an output (e.g., alerts to user and/or the issuing server) and/or taking one or more actions to antagonize the malware.

In one embodiment of the invention, the method further comprises, responsive to determining that the Host Machine is infected with malware or exhibits behavior that is indicative of the presence of malware, generating one or more logging, alerting or preventing tasks.

The invention also encompasses a system for detecting whether disruptive technologies, such as technologies that block, divert or modify network traffic, are present in a Host Machine. The system comprises:
4.—computing apparatus (Host Machine) suitable to receive a web page, resource, or any other information from a server;
5.—computing apparatus (for example, a server) for serving a web page to said Host Machine; and
6.—logical means for determining whether Internet traffic to or from said Host Machine is blocked, diverted, or modified, or is otherwise indicative of the presence of malware.

The system may further comprise software for generating one or more logging, alerting, or preventing tasks, responsive to determining that the Host Machine is infected with malware or exhibits behavior indicative of the presence of malware.

### BRIEF DESCRIPTION OF THE DRAWINGS

FIG. 1 schematically illustrates, in a block diagram form, a system for detecting malware using one more remote servers, according to an embodiment of the invention;

FIG. 2 schematically illustrates, in a process flow diagram form, a system for detecting malware on a Host Machine, according to an embodiment of the invention;

FIG. 3 schematically illustrates, in a block diagram form, components of a system for implementing the invention as a service provided through service provider hosted detection.

FIG. 4 schematically illustrates, in a block diagram form, components of a system in which the invention is implemented as a utility hosted by the party requesting malware detection.

FIG. 5 schematically illustrates, in a block diagram form, components of a system for implementing the invention as a service provider hosted detection.

FIG. 6 is a flow chart diagram representing method steps implemented in an embodiment of the invention using the system as described in FIG. 5.

### DETAILED DESCRIPTION

The invention relates to a system, apparatus and method for detecting and electively disabling disruptive technologies on a computing device. One or more method steps, according to the invention, may be carried out in real-time. In the following description, numerous specific details are set forth to provide a more thorough description of the invention. It will be apparent, however, to one skilled in the pertinent art, that the invention may be practiced without these specific details. In other instances, well known features have not been described in detail so as not to obscure the invention.

### Terminology

Unless otherwise specifically defined, terms, phases and abbreviations used in this disclosure are commonly known in the art of computer programming and may be in use in one or more computer programming languages and the definition of which is available in computer programming dictionaries. However, the use of the later terms, phrases and abbreviation in the disclosure is meant as an illustration of the use of the concept of the invention and encompasses all available computer programming languages provided that the terms, phrases and abbreviations refer to the proper computer programming instruction(s) that cause a computer to implement the invention as disclosed. Prior art publications that define the terms, phrases and abbreviations are included herein by reference.

In the following, the methods and systems according to the invention, unless otherwise specifically indicated, apply to any device capable of manipulating data, which include accessing, processing, storing, transferring or otherwise carrying out any type of data manipulation. Such devices include personal computers (e.g., a laptop or desktop etc.), hardware servers, virtual machines, personal digital assistants, cellular telephones, mobile handsets, tablets, or any other devices operable to query, access and/or input information on a network resource, such as located on the Internet, such as for example, using the World Wide Web (WWW).

A “user” as will be used in this disclosure refers to any person using a computing device, or any process (e.g., a server and/or a client process) that may be acting on behalf of a person or entity to serve data and/or query other devices for specific information.

A “Host Machine” refers to any machine capable of enabling a user or a process to access a network and execute one or more steps of the invention as disclosed. For example, a Host Machine may be a User Terminal such as a stand alone machine or a personal computer running an operating system such as, MAC-OS, WINDOWS, UNIX, LINUX, or any other available operating systems. A Host Machine may be a portable computing device, such as a smart phone or tablet, running a mobile operating system such as iOS, Android or any other available operating system. A Host Machine may be a server, control terminal, network traffic device, router, hub, or any other device that may be able to access data, whether stored on disk and/or memory, or simply transiting through a network device. A Host Machine is typically equipped with hardware and program applications for enabling the device to access one or more networks (e.g., wired or wireless networks), storage means for storing data (e.g., computer memory) and communicating means for receiving and transmitting data to other devices. A Host Machine may be a virtual machine running on top of another system, e.g., on a stand alone system or otherwise in a distributed computing environment, to which it is commonly referred as cloud computing.

In the following disclosure, a Uniform Resource Locator (URL) refers to the information required to locate a resource accessible through a network. On the Internet, the URL of a resource located on the World Wide Web usually contains the access protocol, such as HyperText Transport Protocol (HTTP), an Internet domain name for locating the server that hosts the resource, and optionally the path to a resource (e.g., a data file, a script file, and image or any other type data) residing on that server. For example, the URL comprising (http, www.hmco.com and /trade/) points a user's browser to access the main file (not shown, but implicitly referred as “index”), of a directory named “trade” on the server named “www.hmco.com” using the HTTP.

An ensemble of resources residing on a particular domain, and any affiliated domains or sub-domains, are typically referred as a WWW site, or “website” in short. For example, data documents, stylesheets, images, scripts, fonts, or other files are referred to as resources.

An operator (or process) of a Host Machine may access a website, for example, by clicking on a hyperlink to the website. The user may then navigate through the website to find a web page of interest. Public information, personal information, confidential information, and/or advertisements may be presented or displayed via a browser window in the Host Machine or by other means known in the art (e.g., pictures, video clips, etc.).

Unless otherwise specifically referenced, “malware”, or alternatively computer disruptive technology, refers to any computer program code, such as binary code that may be directly executed by the central processing unit (CPU) of a computer, a script in an interpreted language that may be executed by an interpretation engine (e.g., Javascript, a directive (e.g., browser commands), or any other computer program code that is able to cause the Host Machine to act with the goal of disrupting the Host Machine's proper operation and/or compromise the integrity and/or privacy of the data.

Malware may be installed on and/or may operate on a Host Machine without the knowledge and/or consent of the user of a Host Machine. Malware may include software commonly known as viruses, spyware, adware, keyloggers, worms, Trojans, ransomware, rootkits, bootkits, backdoors or any other exploits that may affect the operation of the Host Machine and/or the security of the data stored on the host machine (e.g., on a permanent storing medium such a magnetic disk or a solid state drive), transiting through the host machine (e.g., stored within the computer memory such as in a networking appliance) and/or acquired through one or more user interfaces (e.g., keyboard, camera, microphone etc), internally generated data (e.g., the result of processing carried out within the host machine) or any other types of data.

A reference to an “infection” (or infected host) refers to when a Malware is installed on a Host Machine and is allowed to be executed and carry out its disruptive functions.

A reference to an Internet Traffic Testing Resource (ITTR) defines a remote location (e.g., a server located on the Internet) enabled to serve data, to receive (and to respond to) requests for resources, and establish communication (and query) resources on the network from other machines (e.g., host machines and/or other servers). For example, an ITTR may be a server run by a third-party security supplier that responds to host machine queries. The server may be configured to serve specific encoded messages, in response to host machine encoded requests, thus enabling the host machine to test that network communications are not compromised by malware.

### Overview of the Concept

Malware is typically designed to implement specific operations that allow it to carry out its goals, such as secretly transferring data to a remote location and/or avoiding detection by Malware detection and/or removal software. To carry out its operations, malware enables, for example, Internet communication on certain network ports that should typically be disabled; and in order to prevent detection, malware may block access to anti-malware resources.

Embodiments of the invention utilize the atypical state of the infected host resulting from the operation of Malware in order to detect the presence of Malware.

There exists numerous solutions, commonly referred as anti-malware, for diagnosing whether a computer has been infected with Malware and inactivating and/or removing the Malware. The existing anti-malware programs typically scan the permanent storage medium (e.g., hard drive) and/or the memory in search of a specific computer code or patterns of stored data, commonly referred as the “signature”, in order to determine the file(s) containing the program code for the Malware and the configuration for the Malware installation, which then can be used to inactivate and/or remove the Malware.

However, Malware frequently updates itself to change its signatures in order to avoid detection. The latter forces the anti-malware producers to constantly monitor the changes in each specific Malware, which may occur over a large number of machines distributed over the network, and provide updated definitions of the signature to the anti-malware software running on the Host Machine in order to detect any and all version of a specific Malware. Thus, anti-malware programs must frequently access a remote location to download an updated list of definitions in order to remain up-to-date.

Anti-malware resources include but are not limited to anti-malware software vendor websites (for example, Mcafee.com), anti-malware research organization websites (for example, ProjectHoneypot.org), or software update websites (for example, Update.Microsoft.com). Anti-malware resources and other Internet resources used to determine the ability of a Host Machine to successfully communicate across a network are referred to as Internet Traffic Testing Resources (ITTR).

However, Malware programs are typically designed to disrupt access to network resources known to update anti-malware programs, update operating systems, research malware infections, or perform other actions detrimental to the malware operator and/or creator. The latter and other atypical behaviors are the object of detection by embodiments of the invention in order to determine that a Malware is operating on a Host Machine.

In embodiments of the invention, and as will be exemplified below, in the process of downloading a resource (e.g., a web page) onto a Host Machine, one or more computer program code pieces, to which it is alternately referred below as “logical means”, is/are inserted within the content of the page to carry out malware detection and provide an indication of whether or not the Host Machine is infected with malware.

The logical means may comprise means for checking whether the Host Machine exhibits Internet traffic blocking, diverting, or modifying behavior indicative of malware infection. The means for checking may be of different types known to one with ordinary skills in the art, it may comprise software running on the user's PC and/or on remote computing apparatus, or may be embedded in hardware, such as a dedicated appliance, network appliance or in any other computing device for handling data.

Host machine states that may result from the presence/operation of Malware comprise blocked access to anti-malware resources to prevent disinfection of Host Machines, enabled Internet communication on typically disabled ports to send and receive information to and from Command-and-Control servers used to operate the malware, to further spread the malware (e.g., by sending unsolicited email using the host's personal contact data), or to attempt to compromise additional Host Machines (e.g., launching denial of service attacks). The latter are examples, and not an exhaustive list. One with ordinary skills in the art of computer security and programming is familiar with a plurality of host machine states that result from the presence and/or operation of a disruptive technology.

In embodiments of the invention, if malware is detected, the specific type of malware attack may be determined, and optionally, action may be taken, such as completely disabling a hyperlink in a web page; alternatively, the web page may be modified such that a warning or assistance message is displayed; further, the page may be modified so that clicking on a link on the web page does not cause a link to be followed but rather causes a warning or assistance message to be displayed. Upon detection of malware, the detection procedure may additionally cause an alert to be sent to the website operator, to the malware detection service provider or to any other party.

It will be appreciated that the website server that hosts the original web page may not be directly involved in scanning a Host Machine for malicious behavior, although in some embodiments it may be advantageous for the scanning means to reside on the same server that hosts the original web page. The detection procedure of the web pages may be performed using processes within the browser application itself and a remote server or servers, as will be fully explained hereinafter.

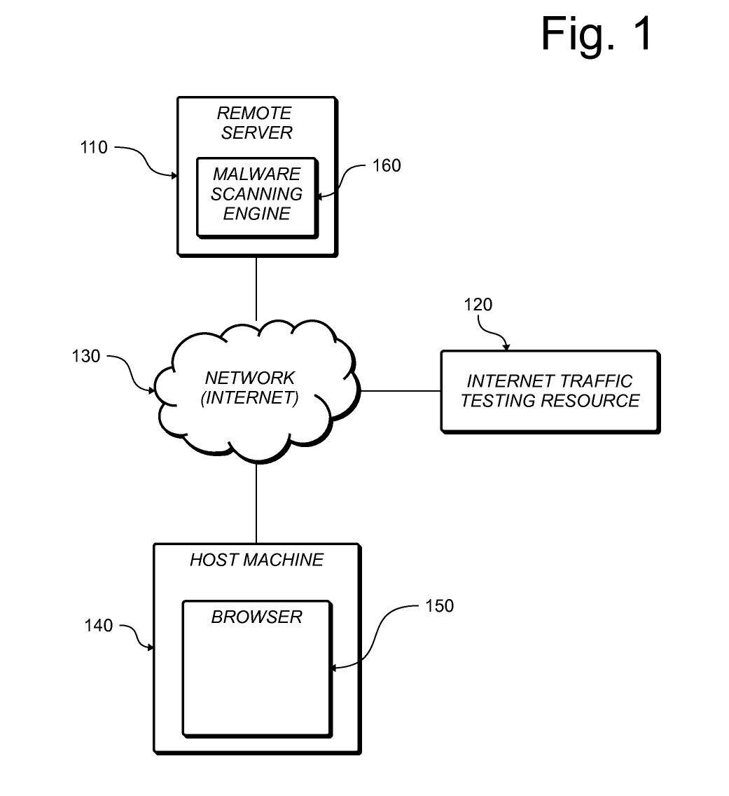

FIG. 1 is a block diagram which schematically illustrates a system for detecting malware using one or more remote servers, according to an embodiment of the invention. A system generally comprises a remote server 110, a network 130, an Internet Traffic Testing Resources (ITTR) 120, one or more Host Machines 140 provided with web browsing capabilities, such as browser 150, and a number of network appliances and servers (not shown) involved in carrying data serving and network data traffic.

Browser 150 may be any application suitable to provide network resource access and browsing capabilities. A browser may be enabled to communicate using one or more network communication protocols, interpret network data (e.g., execute Javascript instruction, load/unload and execute plug-in code), render test graphics, multimedia content and handle any other type of data.

In the example of FIG. 1, remote server 110 comprises a malware scanning engine 160, which is computer program code enabled to scan a Host Machine 140 that requests a webpage for displaying by browser 150 over network 130. The malware scanning engine is submitted to the Host Machine as part of a response to an HTTP request, and may include data from the ITTR server 120 to detect the presence of Internet traffic blocking, diverting, or modifying behavior. If the malware scanning engine detects the presence of such behavior, the result is communicated back to the remote server 110 that may log the information, notify the User using Host Machine 140 or alert any other party (e.g., system administrators) of the detection. As an option, remote server 110 may take any appropriate action to prevent the malware from disrupting operations on the Host Machine 140.

Network 130 may be any interconnecting system and may utilize any suitable protocol and technologies capable of transmitting information such as audio, video, signals, data, messages, or any combination thereof.

Remote server 110 may be any suitable device operable to process web pages or resources displayed by Host Machine 140 and obtained as described above. Examples of remote server 110 may include a Host Machine, workstation, web server, file server, a personal Host Machine such as a laptop, or any other device operable to process web pages or resources displayed on terminal 140. Remote server 110 may include any operating system such as MAC-OS, WINDOWS, UNIX, LINUX, or other appropriate operating systems.

Listing 1 (shown below) is a computer program listing representing computer program pseudo-code designed to carry out the testing of the presence of malware by the scanning engine, as described above, on a Host Machine. Listing 1 represents code which one with ordinary skills in the art of computer programming would utilize to draft specific programming code or a combination of available programming languages. Such languages comprise interpreted scripting languages (e.g., Javascript, PERL, PHP, etc.), compiled program code (e.g., C, C++, JAVA etc.) or any other directive that is capable of causing a host to execute computer program to carry the testing for malware as taught by the invention.

Listing 1

1 get token_set
2 foreach element in token_set
3 test element
4 if test = success
5 then
6 continue
7 else
8 generate alert
9 continue
10 end foreach loop

The scanning engine obtains a set of tokens (or indicia) (e.g. line 1). The engine is enabled to interpret each token (or element) in the set (e.g. line 2) as a specific instruction to carry out one or more testing/scanning steps (e.g., line 3). The element in the set may also contain all the necessary information to carry out a detection. Such information comprises the type of testing, a URL, the server address for returning test results or any other parameter required to carry out the steps of the invention. For example, a token may carry the instruction of establishing a network connection with a specific remote host and retrieve a specific resource, which would be indicative that access to the resource is not blocked from/to the Host Machine. Using the latter example, if the network connection is properly established, then the testing/scanning using a particular token does not reveal a state indicative of the presence of malware. Otherwise, if the testing/scanning reveals that access to said resource is blocked (e.g., line 8), then the engine may log the information, generate a connection to the server that serves the webpage and communicate to a monitoring facility and/or to a server provider.

Any token, in accordance with embodiments of the invention, may be encrypted, mutated of otherwise manipulated in order to prevent that malware programs identify and attempt to defeat embodiments of the invention.

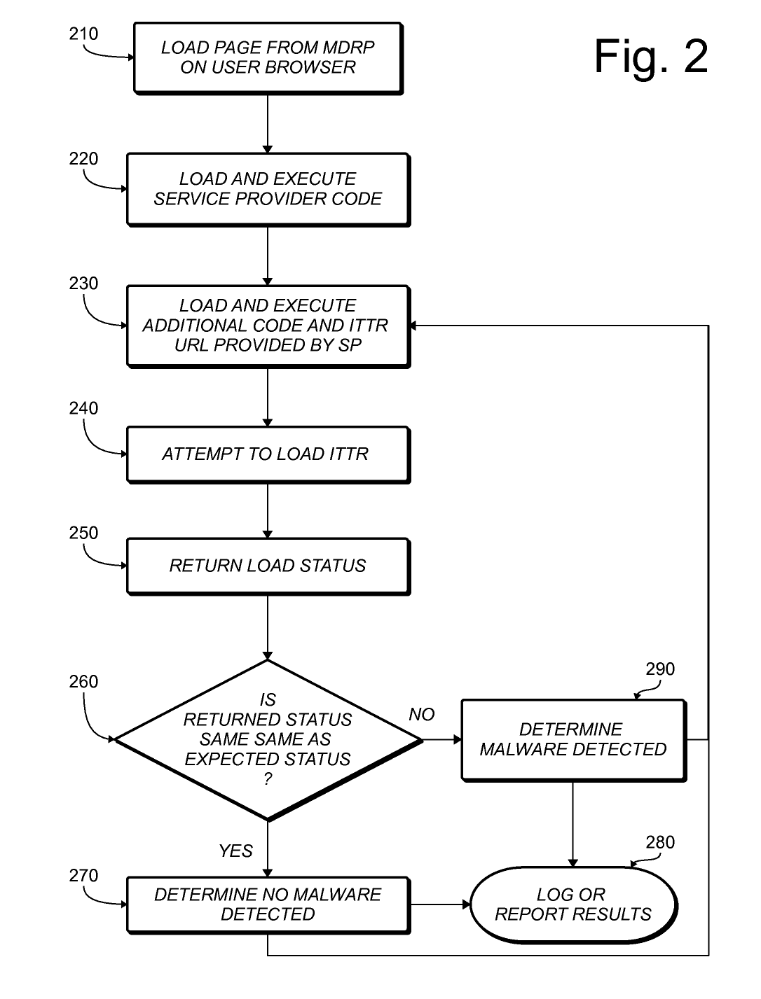

FIG. 2 is a flowchart diagram schematically illustrating method steps for detecting malware on a Host Machine, according to an embodiment of the invention. At step 210 Host Machine loads a webpage from a website or ad operated by or for the benefit of a Malware Detection Requesting Party (MDRP). The webpage may contain requests to load additional code from the service provider (SP, e.g., server 110). At step 220, the code loaded from the SP is executed on the Host Machine (e.g., in browser 150). The executed code may further request additional code and/or Internet Traffic Testing Resources (ITTR) URLs, at step 230. Code provided by the SP may attempt to load/reach one or more ITTRs received step 240.

At step 250, the result of the attempt to reach ITTRs is returned to the SP server. At step 260, the SP server uses a logical means to determine if the resulting status matches the expected status result. If the resulting status of ITTRs requested to be loaded on the Host Machine match the expected resulting status, SP determines, at step 270, that no indication of Internet traffic blocking, diverting, or modifying behavior is detected and that malware exhibiting behavior of that type is not detected on the Host Machine. The resulting determination may be logged or reported to the MDRP at step 280. Host Machine may proceed to loading additional ITTRs to be used for further attempt to detect malware at step 230.

If the resulting status of ITTRs requested to be loaded on the Host Machine do not match the expected resulting status, SP determines that Internet traffic blocking, diverting, or modifying behavior is detected and that malware exhibiting behavior of that type is detected on the Host Machine 290. The resulting determination may be logged or reported to the MDRP 280. As an option, SP may take any appropriate action to prevent the malware from harming the operator of Host Machine or the MDRP. The Host Machine may be retested or more deeply examined with the same or different ITTR URLs to aid in increasing the confidence of the determination by repeating same (or similar steps) as steps 230 to 260.

According to one embodiment of the invention the page or resource provided to the user by the web server may contain functional code (for example, JavaScript, Asynchronous JavaScript, ActiveX, JAVA Applet, a browser embedded extension or module, a plugin i.e. a resource requiring the invocation of a local application or any computer program code capable of executing program instructions on the Host Machine) that is suitable to provide to the scanning apparatus information required to perform the desired analysis.

In an embodiment of the invention, three elements play a role in the process of detecting malware:
1) A Malware Detection Requesting Party (MDRP), which hosts a web page or resource (such as an advertising unit) to be requested by a Host Machine;
2) a Host Machine that communicates with the MDRP via a browser; and
3) a Service Provider (SP), which carries out the active part in the malware discovery process, as will be explained hereinafter.

The MDRP hosts a HyperText Markup Language (HTML) web page (for example, a log-in page). The web page may contain a visible or invisible component, e.g., Iframe, provided by (or coordinated with) the Service Provider. When the Host Machine receives the web page in its browser the Iframe sends a request to the SP server, which supplies it in response to the iframe. The response contains a JavaScript (JS), which makes a request to an ITTR and sends the response and/or load status to the SP, where it is analyzed to determine whether the Host Machine shows behavior indicative of a malware infection.

In an alternative embodiment of the invention, instead of including an invisible Iframe in the HTML that the Host Machine receives from the MDRP, and then obtaining the JS from the SP, the JS is already contained in the website provided by the MDRP and therefore it sends the request for additional JavaScript and/or the response and/or load status of a call to an ITTR directly to the SP, without the need for the intermediate stage of loading an Iframe, as discussed previously.

In embodiments of the invention, the failure to establish a connection and optionally complete a request of a resource from a Host Machine to an ITTR, known to be available and reachable, may be interpreted as indicative of the presence of a running agent (e.g., malware) that blocks, diverts, or modifies Internet traffic from the Host Machine.

A request may be thought of as any request of information that goes through a network to access a resource on a server or Host Machine. For example, an HTTP request originating from a User Terminal may contact a server in an effort to obtain a file. The server may respond to the request with an acknowledgment that the file exists and then transmit the file. As used in this document, a completed request to an ITTR comprises a request for a resource, a positive response from the resource host (e.g., server) that the resource exists, and a successful transmission and loading of that resource from the resource host to the User Terminal.

Alternatively, a request made from a Host Machine to an ITTR that is known not to exist, which returns a result indicating that it was successfully reached or loaded may be interpreted as Internet traffic blocking, diverting or modifying behavior acting in stealth mode.

For example, a request made from a Host Machine to an ITTR that is known to exist, is requested on a network port that is typically disabled, and returns a result indicating that it was successfully reached or loaded may be interpreted as Internet traffic blocking, diverting or modifying behavior.

As is known to those skilled in the art, combinations, derivations, or iterations of the testing processes noted above may be used to determine if Internet traffic from a Host Machine is being blocked, diverted, or modified.

As will be apparent to the skilled person, the invention allows the indirect but extremely efficient, near real-time detection of malware on a Host Machine, by using the response of a Host Machine to a request or requests to ITTRs. The following examples illustrate specific embodiments of the invention.

### Example 1

### Service Provider Serving Detection Program Code

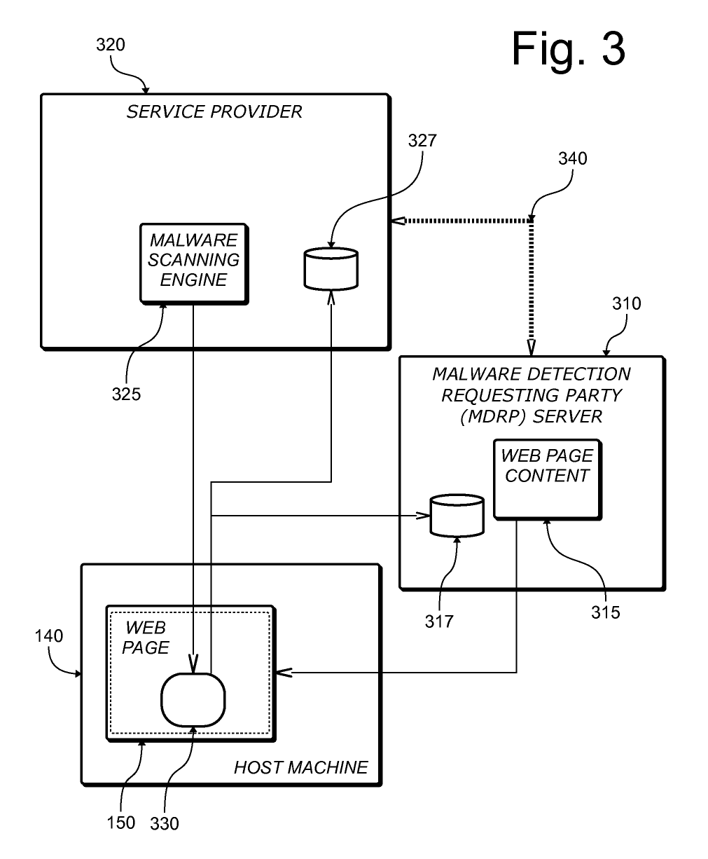

FIG. 3 is a block diagram representing components of a system for implementing the invention as a service provided through service provider hosted detection. In this example, the malware detection requesting party's (MDRP) 310 site is the site to which a user navigates to download a web page 315. The party requesting detection may be a financial institution's (e.g., Bank) web site that enables customers to authenticate with the website, then carry out a multitude of financial transactions. The bank's website may cooperate with the malware detection service provider (e.g., 320), in order to check whether the bank's customers' computers (Host Machines) may be infected by malware (e.g., executing a key logger program).

Within the page content 315 is embedded a request to download a program code 330 from the malware scanning engine 325 of the service provider. The service provider serves up the computer program code 330, which executes within the browser 150 and carries out the actual malware detection, and may return the result to the MDRP via the browser directly to a reporting/logging database (e.g., on the MDRP system 317 and/or on the Service Provider's system 327) or via a different communication path (e.g., 340).

The MDRP Site may embed a small HTML/JavaScript (JS) snippet (provided at setup time by the SP) that may embed an invisible (or near invisible) iframe in the content which comes from the MDRP Site. Alternatively, the snippet may embed additional JS into the MDRP Site without the use of an iframe.

The iframe and/or JS makes a request to the SP server, which may return the URLs for a plurality (e.g., three, 3) different ITTRs, along with additional JS. The additional JS makes requests to the ITTRs from the Host Machine 140 and determines if the resources were successfully loaded by the Host Machine. The JS then returns the resulting status of the load attempts to the SP. SP uses a logical means to compare the received load status results with the expected load status results and uses that comparison to determine if Internet traffic blocking, diverting, or modifying behavior is detected in the Host Machine.

Alternatively, the SP may elect to not execute the malware detection process on the Host Machine. This election may be made, for example, based on the outcome and/or timeliness of past detection events. Information regarding the outcome or timeliness of past detection events may be stored on the Host Machine, for example, in browser cookies or local storage. Information regarding the outcome or timeliness of past detection events may also be stored with the SP or MDRP and associated with the Host Machine using machine identification information, such as browser cookies or Internet Protocol (IP) address. Information stored on the Host Machine may be encrypted using a key known only to the SP to prevent unauthorized modification of the information.

In the example above, the server can record the infection status for later retrieval, or send an alert immediately to the MDRP and/or to other parties. Another variant may return the infection status to the browser along with additional JS that may act upon it in real time, e.g. alerting the user, preventing certain actions, or disabling certain functionality.

### Example 2

### Single Server Serving Detection Program Code

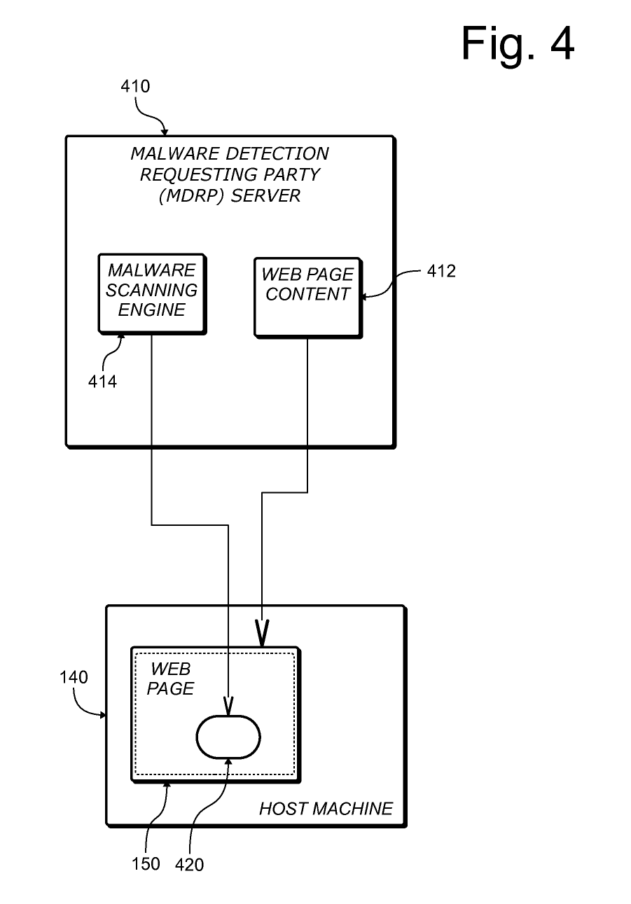

FIG. 4 is a block diagram representing components of a system in which the invention is implemented as a utility hosted by the party requesting malware detection. In this embodiment, the Malware Detection Requesting Party's (MDRP) 410 site is the site to which the user navigates to download a web page 412. The site may host the detection software 414, for example, in cooperation with a Service Provider (SP). The detection software is served up to a user's browser (e.g. 150) in a Host Machine (e.g. 140) where it carries out the actual malware detection, and may return the result to the MDRP via the browser or via a different path.

The MDRP Site may embed a small HTML/JavaScript (JS) snippet (e.g., 420) that may embed an invisible (or near invisible) iframe in the content which comes from the MDRP Site. Alternatively, the snippet may embed additional JS into the MDRP Site without the use of an iframe.

The iframe and/or JS makes a request to the MDRP server, which returns the URLs for a plurality (e.g., three, 3) different ITTRs, along with additional JS. The additional JS makes requests to the ITTRs from the Host Machine and determines if the resources were successfully loaded by the Host Machine. The JS then returns the resulting status of the load attempts to the MDRP. MDRP uses a logical means to compare the received load status results with the expected load status results and uses that comparison to determine if Internet traffic blocking, diverting, or modifying behavior is detected in the Host Machine.

In the example above, the server may record the infection status for later retrieval, or send an alert immediately to other parties. Another variant may return the infection status to the browser along with additional JS that may act upon it in real time, e.g. alerting the user, preventing certain actions, or disabling certain functionality.

### Example 3

### Third-Party Serving Detection Program Code

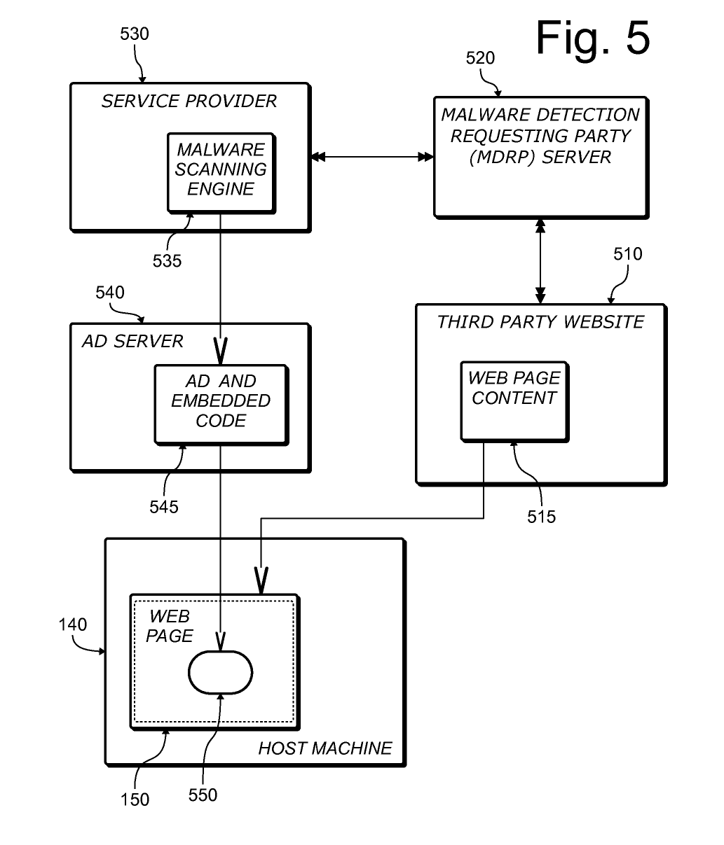

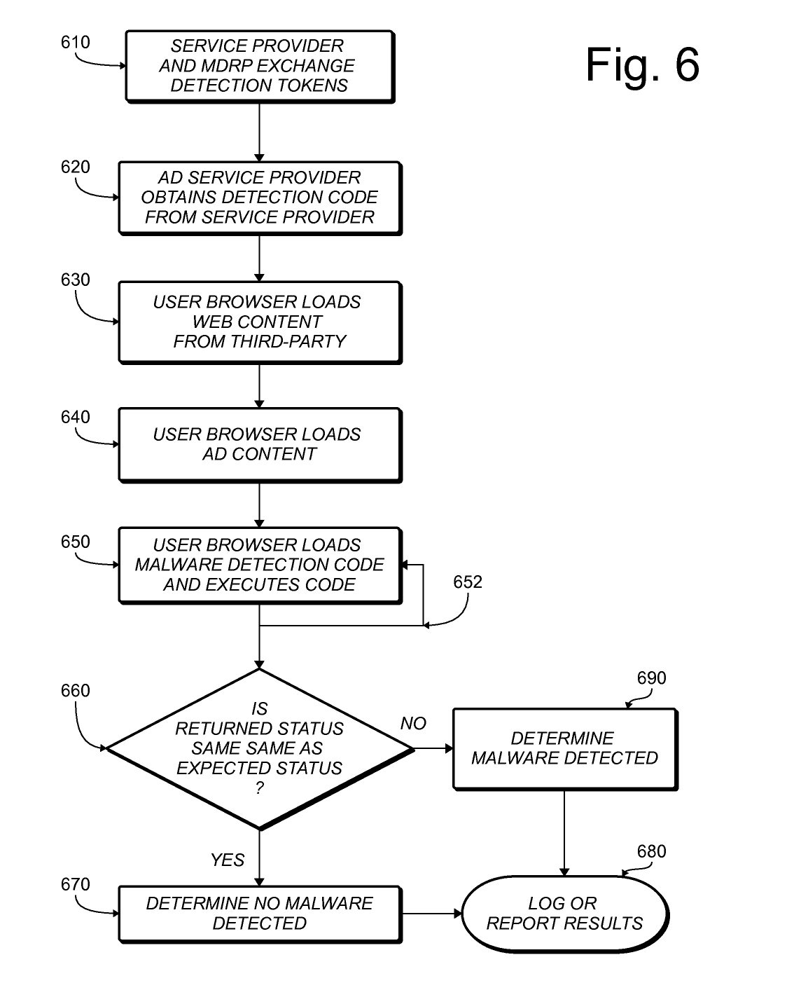

FIG. 5 is a block diagram representing components of a system for implementing the invention as a service provider hosted detection. FIG. 6 is a flow chart diagram representing method steps using the system represented in FIG. 5. In this embodiment, the user navigates to any third party site 510 to download a web page 515 that contains one or more requests for one or more ads (e.g., 545) for the benefit of the Malware Detection Requesting Party (MDRP) 520. This example utilizes advertising (Ad) as an illustration of use of third party content 515. Ads can be substituted with any content or resources hosted or served by a third-party for the benefit of the MDRP. The MDRP cooperates with Service Provider (SP) 530 (e.g., step 610) which may host the detection software 535 which serves up code that carries out the actual malware detection in user browser 150. The ad service provider (e.g., 540) may obtain the detection code at step 620.

The MDRP embeds a small HTML/JavaScript (JS) snippet (provided at setup time by the SP) into the ad or ads (e.g., 545) served by the ad server 540 (e.g., step 630). The snippet may be placed anywhere inside or outside the container that serves one or more ads (e.g., step 640). The snippet may embed an invisible (or near invisible) iframe 550 in the container for the ad or ads (e.g., step 650). Alternatively, the snippet may embed additional JS inside or outside the container (e.g., loop 652) without the use of an iframe.

The iframe and/or JS makes a request to the SP server, which returns the URLs for a plurality (e.g., three, 3) different ITTRs, along with additional JS. The additional JS makes requests to the ITTRs from the Host Machine 140 and determines if the resources were successfully loaded by the Host Machine. The JS then returns the resulting status of the load attempts to the SP. SP uses a logical means to compare the received load status results with the expected load status results and uses that comparison to determine if Internet traffic blocking, diverting, or modifying behavior is detected in the Host Machine (represented by steps 660, 670, 680 and 690).

In the latter example, the server can record the Host Machine malware infection status for later retrieval, or send an alert immediately to the MDRP and/or to other parties. Another variant may return the infection status to the browser along with additional JS that may act upon it in real time, e.g. alerting the user, preventing certain actions, or disabling certain functionality. The SP may return the result to the MDRP via the browser or via a different path.

### Example 4

### Detecting Malware Resistance

Similar to the embodiment described in EXAMPLE 1, in another embodiment of the invention it is assumed that the malware is aware of the invention as disclosed in the present disclosure, and it is assumed that the malware would attempt to defeat the detection mechanism and/or logic means that is part of an embodiment of the invention.

In this embodiment, the Malware Detection Requesting Party's (MDRP) site is the site to which the user navigates. It cooperates with the Service Provider (SP) which carries out the actual malware detection, and may return the result to the MDRP via the browser or via a different path.

The MDRP Site embeds a small HTML/JavaScript (JS) snippet (provided at setup time by the SP) that may embed an invisible (or near invisible) iframe in the content which comes from the MDRP Site. Alternatively, the snippet may embed additional JS into the MDRP Site without the use of an iframe.

The iframe and/or JS makes a request to the SP server, which returns the URLs for a plurality (e.g., three, 3) different ITTRs, along with additional JS. Of the different ITTRs, two are known to exist and one is known not to exist. The additional JS makes requests to the three ITTRs from the Host Machine and determines if the resources were successfully loaded by the Host Machine. The JS then returns the resulting status of the load attempts to the SP. SP uses a logical means to compare the received load status results with the expected load status results and uses that comparison to determine if Internet traffic blocking, diverting, or modifying behavior is detected in the Host Machine. If the ITTR that was known not to exist returns a load status indicating that it was successfully loaded, the SP may interpret this as attempted malware resistance and determine that the Host Machine is exhibiting Internet traffic blocking, diverting, or modifying behavior.

In this example, the server may record the infection status for later retrieval, or send an alert immediately to the MDRP and/or to other parties. Another variant may return the infection status to the browser along with additional JS that may act upon it in real time, e.g. alerting the user, preventing certain actions, or disabling certain functionality.

### Example 5

### Detecting Malware Resistance Using ITTR Cooperation

Similarly to the embodiments described in EXAMPLE 1 and EXAMPLE 4, in an embodiment of the invention, it is assumed that the malware attempts to defeat the detection mechanism and/or logic means that is part of an embodiment of the invention and the ITTR cooperates with the Service Provider to overcome malware resistance.

In this embodiment, the Malware Detection Requesting Party's (MDRP) site is the site to which the user navigates. The Service Provider (SP) carries out the actual malware detection, in cooperation with the MDRP, and may return the result to the MDRP via the browser or via a different path.

The MDRP Site embeds a small HTML/JavaScript (JS) snippet (provided at setup time by the SP) that embeds an invisible (or near invisible) iframe in the content which comes from the MDRP Site. Alternatively, the snippet may embed additional JS into the MDRP Site without the use of an iframe.

The iframe and/or JS makes a request to the SP server, which returns the URLs for a plurality (e.g., three, 3) different ITTRs, along with additional JS. The URL for one or more of the resources contains a dynamically generated resource name or dynamically generated parameters. The dynamically generated name or parameter may be generated using an algorithm not known to the public, but known to the ITTR cooperating with the Service Provider. The dynamically generated name or parameter may be based on unique identifying characteristics of the Host Machine (e.g., IP address or Mac Address), and may include date and time indicators, such as the current date and hour, in an effort to associate the dynamic name or parameter with the Host Machine being examined and prevent unauthorized and/or repeat use. Further, the dynamically generated name or parameter may be encrypted using a private encryption key known only to the SP and/or ITTR in an effort to prevent reverse engineering of the name or parameter generation convention or circumvention of the dynamic testing process. Some dynamically generated names or parameters will be known to correspond to and return a valid resource, while others will not be associated with a valid resource. Further, the SP and ITTR may take steps to ensure that the request for resource originating from a Host Machine is using a name or parameter generated for that specific Host Machine by examining the identifying characteristics unique to the Host Machine, as noted above.

The additional JS makes requests to the ITTRs from the Host Machine and determines if the resources were successfully loaded by the Host Machine. The JS then returns the resulting status of the load attempts to the SP. SP uses a logical means to compare the received load status results with the expected load status results and uses that comparison to determine if Internet traffic blocking, diverting, or modifying behavior is detected in the Host Machine. If the ITTR that was known not to exist returns a load status indicating that it was successfully loaded, the SP may interpret this as attempted malware resistance and determine that the Host Machine is exhibiting Internet traffic blocking, diverting, or modifying behavior. Further, if a Host Machine attempts to load an ITTR with a dynamic name or parameter that was not intended for that specific Host Machine, the SP may interpret this as attempted malware resistance and determine that the Host Machine is exhibiting Internet traffic blocking, diverting, or modifying behavior. The benefit of employing dynamically generated file names or parameters is to prevent the malware operator from being able to check for the resource existence in advance or use prior knowledge from prior Internet traffic to determine resource existence in an effort to provide false information to the testing mechanism.

In the example above, the server can record the infection status for later retrieval, or send an alert immediately to the MDRP and/or to other parties. Another variant may return the infection status to the browser along with additional JS that may act upon it in real time, e.g. alerting the user, preventing certain actions, or disabling certain functionality.

### Example 6

### Detecting Malware Resistance Using ITTR Cooperation and Two-Way Communication Via the Host Machine

Similarly to the embodiment described in EXAMPLE 5, in an embodiment of the invention, it is assumed that the malware attempts to defeat the detection mechanism and/or logic that is part of the invention and the ITTR cooperates with the Service Provider, communicating via the Host Machine, to overcome malware resistance.

In this embodiment, the Malware Detection Requesting Party's (MDRP) site is the site to which the user navigates. The Service Provider (SP) carries out the actual malware detection, in cooperation with the MDRP, and may return the result to the MDRP via the browser or via a different path.

The MDRP Site embeds a small HTML/JavaScript (JS) snippet (provided at setup time by the SP) that embeds an invisible (or near invisible) iframe in the content which comes from the MDRP Site. Alternatively, the snippet may embed additional JS into the MDRP Site without the use of an iframe.

The iframe and/or JS makes a request to the SP server, which returns the URLs for a plurality (e.g., three, 3) different ITTRs, along with additional JS. The URL for one or more of the resources contains a dynamically generated resource name or dynamically generated parameters, as described in EXAMPLE 5. Some dynamically generated names or parameters will be known to correspond to and return a valid resource, while others will not be associated with a valid resource. Further, the ITTR may return information via the response to the request for a resource that is specific to the dynamic name or parameter. For example, the SP may use a dynamic parameter that contains the Host Machine IP address, current date, and current hour. The SP may encrypt that information using a key only know to the SP and ITTR. The ITTR, at the time of the request from the Host Machine, may decrypt the parameter, perform a function, such as counting the number of even digits in the parameter, encrypt the result, and return it to the Host Machine. This result may be thought of as communication validation information. The Host Machine may then pass that information, along with the load status, to the SP, which may decrypt the information and use a logical means to determine if it matches the results expected from the predetermined function. This process will allow the Service Provider to confirm that communication was established with the ITTR and was not falsely indicated by the malware.

The additional JS makes requests to the ITTRs from the Host Machine and determines if the resources were successfully loaded by the Host Machine. The JS then returns the resulting status of the load attempts to the SP. SP uses a logical means to compare the received load status results with the expected load status results and uses that comparison to determine if Internet traffic blocking, diverting, or modifying behavior is detected in the Host Machine. If while attempting to load a resource from the ITTR that was known not to exist the Host Machine returns a load status indicating that it was successfully loaded, the SP may interpret this as attempted malware resistance and determine that the Host Machine is exhibiting Internet traffic blocking, diverting, or modifying behavior. Further, if a Host Machine attempts to load an ITTR with a dynamic name or parameter that was not intended for that specific Host Machine, the SP may interpret this as attempted malware resistance and determine that the Host Machine is exhibiting Internet traffic blocking, diverting, or modifying behavior. Further, if a Host Machine reports communication with and loading of a resource from an ITTR but does not return the correct validation information from the ITTR the SP may interpret this as attempted malware resistance and determine that the Host Machine is exhibiting Internet traffic blocking, diverting, or modifying behavior.

In the example above, the server can record the infection status for later retrieval, or send an alert immediately to the MDRP and/or to other parties. Another variant may return the infection status to the browser along with additional JS that may act upon it in real time, e.g. alerting the user, preventing certain actions, or disabling certain functionality.

### Example 7

### Detecting Malware Resistance and ITTR Cooperation with Two-Way Communication Independent of the Host Machine

Similarly to the embodiment described in EXAMPLE 5, in an embodiment it is assumed that the malware attempts to defeat the detection mechanism and/or logic means that is part of an embodiment of the invention and the ITTR cooperates with the Service Provider, communicating directly with the SP, to overcome malware resistance.

In this embodiment, the Malware Detection Requesting Party's (MDRP) site is the site to which the user navigates. The Service Provider (SP) carries out the actual malware detection, in cooperation with the MDRP, and may return the result to the MDRP via the browser or via a different path.

The MDRP Site embeds a small HTML/JavaScript (JS) snippet (provided at setup time by the SP) that embeds an invisible (or near invisible) iframe in the content which comes from the MDRP Site. Alternatively, the snippet may embed additional JS into the MDRP Site without the use of an iframe.

The iframe and/or JS makes a request to the SP server, which returns the URLs for three different ITTRs, along with additional JS. The URL for one or more of the resources contains a dynamically generated resource name or dynamically generated parameters, as described in EXAMPLE 5. Some dynamically generated names or parameters will be known to correspond to and return a valid resource, while others will not be associated with a valid resource. Further, the ITTR may transmit information directly to the SP in response to the request for a resource from a Host Machine. For example, the SP may use a dynamic parameter that contains the Host Machine IP address, current date, and current hour. The SP may encrypt that information using a private encryption key known only to the SP. The ITTR, at the time of the request, may transmit that information to the SP, indicating that communication has been established between the Host Machine and the ITTR. The SP may then use this information to confirm the validity of reported communication to the ITTR from the Host Machine. For example, if the JS executed on the Host Machine indicates that the Host Machine has successfully communicated with and/or loaded a resource from the ITTR, but the ITTR does not transmit information to the SP indicating the successful communication from the Host Machine, the SP may conclude that malware present on the Host Machine is attempting to falsely report successful communication with the ITTR and/or a successful load of a resource from the ITTR. This process will allow the Service Provider to confirm that validity of communication between the Host Machine and the ITTR.

The additional JS makes requests to the three ITTRs from the Host Machine and determines if the resources were successfully loaded by the Host Machine. The JS then returns the resulting status of the three load attempts to the SP. SP uses a logical means to compare the received load status results with the expected load status results and uses that comparison to determine if Internet traffic blocking, diverting, or modifying behavior is detected in the Host Machine. If while attempting to load a resource from the ITTR that was known not to exist the Host Machine returns a load status indicating that it was successfully loaded, the SP may interpret this as attempted malware resistance and determine that the Host Machine is exhibiting Internet traffic blocking, diverting, or modifying behavior. Further, if a Host Machine attempts to load an ITTR with a dynamic name or parameter that was not intended for that specific Host Machine, the SP may interpret this as attempted malware resistance and determine that the Host Machine is exhibiting Internet traffic blocking, diverting, or modifying behavior. Further, if a Host Machine reports communication with and loading of a resource from an ITTR that does not confirm communication with or a resource request from that Host Machine, the SP may interpret this as attempted malware resistance and determine that the Host Machine is exhibiting Internet traffic blocking, diverting, or modifying behavior.

In the example above, the server can record the infection status for later retrieval, or send an alert immediately to the MDRP and/or to other parties. Another variant may return the infection status to the browser along with additional JS that may act upon it in real time, e.g. alerting the user, preventing certain actions, or disabling certain functionality.

### Example 8

### Detecting Malware with Client-Side Scripting Disabled

This embodiment is similar to that described in EXAMPLE 1. However, in this embodiment, client-side scripting, such as JavaScript, is disabled on the Host Machine.

In this embodiment, the Malware Detection Requesting Party's (MDRP) site is the site to which the user navigates. The Service Provider (SP) carries out the actual malware detection, in cooperation with the MDRP, and may return the result to the MDRP via the browser or via a different path.

The MDRP Site embeds a small HTML snippet (provided at setup time, for example, by the SP). This snippet may be placed directly into the MDRP site or into an iframe on the MDRP site.

The HTML snippet causes a browser to make requests to a plurality (e.g., three) different ITTRs. The URL for one or more of the ITTRs contains a dynamically generated resource name or dynamically generated parameters, as described in EXAMPLE 5. The ITTRs may transmit information directly to the SP in response to the request for a resource from a Host Machine. This transmission may occur in real time or at regular intervals. This transmission may utilize an application programming interface, log files, or any other means of transmitting information. For example, the SP may use a dynamic parameter that contains the Host Machine IP address, current date, and current hour. This information may be generated without the use of client-side scripts. The ITTR, at the time of the request from the Host Machine, may transmit that information to the SP, indicating that communication has been established between the Host Machine and the ITTR. The SP may then use this information to confirm the presence of communication to the ITTR from the Host Machine.

SP uses a logical means to compare the received load status results with the expected load status results and uses that comparison to determine if Internet traffic blocking, diverting, or modifying behavior is detected in the Host Machine. For example, if an ITTR does not report communication with a Host Machine, the SP may interpret this as Internet traffic blocking, diverting, or modifying behavior. Further, if a Host Machine attempts to load an ITTR with a dynamic name or parameter that was not intended for that specific Host Machine at that specific time, the SP may also interpret this as Internet traffic blocking, diverting, or modifying behavior.

In the example above, the server can record the infection status for later retrieval, or send an alert immediately to the MDRP and/or to other parties. Another variant may return the infection status to the Host Machine along with additional instructions that may act upon it in real time, e.g. alerting the user, preventing certain actions, or disabling certain functionality.

### Example 9

### Detecting Malware Using Communication Port Scanning

In one embodiment of the invention, the Malware Detection Requesting Party's (MDRP) site is the site to which the user navigates. The Service Provider (SP) carries out the actual malware detection, in cooperation with the MDRP, and may return the result to the MDRP via the browser or via a different path.

The MDRP Site embeds a small HTML/JavaScript (JS) snippet (provided at setup time by the SP) that embeds an invisible (or near invisible) iframe in the content which comes from the MDRP Site.

The iframe makes a request to the SP server, which returns a URL for ITTRs, along with additional JS. The additional JS makes a request to the ITTR using non-standard network ports from the Host Machine and determines if inbound and/or outbound communication was enabled on the Host Machine. The JS then returns the resulting status of the communication attempts to the SP. SP uses a logical means to compare the received load status results with the expected load status results and uses that comparison to determine if Internet traffic blocking, diverting, or modifying behavior is detected in the Host Machine.

In the example above, the server can record the infection status for later retrieval, or send an alert immediately to the MDRP and/or to other parties. Another variant may return the infection status to the browser along with additional JS that may act upon it in real time, e.g. alerting the user, preventing certain actions, or disabling certain functionality.

It should be noted that the quantities used in the examples above are for illustration purposes only and should not be interpreted as limiting the scope of the invention. It should also be noted that detection can also take place in a client-side mechanism (i.e., in the Host Machine), or in a combination of client-side and remote server-side mechanisms.

As will be appreciated by the skilled person the invention is suitable to detect malware regardless of web page modifying agents that may or may not be injected into the web browser or HTML code by the malware, since it bases its detection on Internet traffic blocking, diverting, or modifying behavior commonly found in Host Machines infected with malware that are not reliant on the malware making changes to the web browser or HTML code.

The present invention provides malware detection tools which protect users from being exploited while browsing the web and which protect providers of online content and advertising from being exploited by malware altered browsing behavior and/or attribution. As described above, the system and the method used by the present invention are capable of remotely detecting behavior associated with malware.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention.

1. A method for detecting whether a malware is disrupting network communications or altering security in a computer, the method comprising steps of:
loading at least one resource from at least one server onto a host computer;
executing said at least one resource on said host computer, comprising determining a success of reaching at least one pre-defined remote server, and obtaining from said remote server a pre-defined data for detecting whether network traffic blocking, diverting, or modifying behavior is present in the host computer; and
determining that malware is present in the computer if network traffic blocking, diverting, or modifying behavior is detected.
